(19) United States
(12) Patent Application Publication
(10) Pub. No.: US 2006/0067760 A1
(43) Pub. Date: Mar. 30, 2006

(54) Image forming apparatus, printing system, and image forming device

(75) Inventors: Takashi Shimizu, Kagamihara-shi (JP); Takehiro Masuda, Nagoya-shi (JP); Yasushi Fujiwara, Nagoya-shi (JP)

Correspondence Address: BANNER & WITCOFF, LTD.;Counsel for Brother Industries, 1001 G STREET, N.W., 11TH FLOOR, WASHINGTON, DC, 20001-4597, US

(73) Assignee: Brother Kogyo Kabushiki Kaisha, Nagoya-shi (JP)

(21) Appl. No.: 11/235,706

(22) Filed: Sep. 27, 2005

(30) Foreign Application Priority Data
Sep. 27, 2004 (JP) 2004-280097
Jul. 15, 2005 (JP) 2005-206670

(51) Int. Cl. G03G 15/00

(52) U.S. Cl. 399/377; 399/380

(57) ABSTRACT

An image forming apparatus including: an image reading unit that reads a document and includes: a document table on which the document is placed; a document table cover having one end capable of swinging about the other end thereof, the document table cover rotating in a first direction away from the document table and in a second direction toward the document table, the document table cover being capable of pressing the document; and a positioning portion that positions the document and is provided on the side of the other end of the document table cover; and an image forming unit that forms an image of the document read by the image reading unit on a recording medium, the image forming unit comprising a curl forming part that curls the recording medium so that a surface of the recording medium formed with the image thereon is to be concave.

### BACKGROUND

1. Technical Field

An aspect of the present invention relates to an image forming apparatus, a printing system, and an image forming device, particularly, to an image forming apparatus including an image reading unit and an image forming unit, a printing system constituted by connecting an image reading device and an image forming device, and the image forming device. In the image forming apparatus, the image reading unit has a document table, and reads a document which is disposed on the document table with a surface thereof to be read facing the document table, and the image forming unit forms an image of the document read by the image reading unit on a recording medium.

2. Description of the Related Art

In an image reading device which can be provided in a copying machine reading a document to copy the document and in a multifunction printer having a scanner to read a document corresponding to a FAX transmission, a document is read by irradiating light on the document disposed on a document table glass and then detecting the reflected light. The image reading device is generally provided with a document table cover that has a white film attached to a portion thereof facing the document table glass. When there is a portion of the document table that is not covered with a document, the document table cover prevents the portion from being copied in black.

In the meantime, as an object to be read, there is a case where a curved document needs to be read by the image reading device. However, even though the curved document is aligned on the document table glass to be read in a state that the document table cover is opened, the document is likely to move during the close of the document table cover. Therefore, there is a problem that the document is obliquely read. In order to solve the above-mentioned problem, an image reading device disclosed in JP-A-5-11369 has been proposed. This image reading device has an auxiliary pressing member capable of holding a document on the document table glass in a state that the document table cover is opened.

### SUMMARY

However, a curl of the document depends on various factors, and thus the curl does not always occur in a predetermined position and direction in a conventional image forming device. In the related art disclosed in JP-A-5-11369, a plurality of document pre-pressing members is provided to the image forming device, and a user properly selects one of the document pre-pressing members to handle the curl occurred in the document. In some cases, the document can be pressed by sequential use of the plurality of document pre-pressing members, which cause a problem that operations are complex.

The invention provides an image forming apparatus, a printing system and an image forming device which can properly press a document on a document table with more simple operations.

According to an aspect of the invention there is provided an image forming apparatus including: an image reading unit that reads a document and includes: a document table on which the document is placed; a document table cover having one end capable of swinging about the other end thereof and a document pressing surface formed with an opening, the document table cover rotating in a first direction away from the document table and in a second direction toward the document table, the document pressing surface being capable of pressing the document; and a document pre-pressing member that is received in the opening and has one end capable of swinging about the other end thereof, the document pre-pressing member being capable of rotating in the first direction and in the second direction, the document pre-pressing member being capable of pressing a part of the document on the document table in a state where the document table cover is open; and an image forming unit that forms an image of the document read by the image reading unit on a recording medium, the image forming unit comprising a curl forming part that curls the recording medium so that a surface of the recording medium formed with the image thereon is to be concave.

In the image forming apparatus according to the aspect of the invention, since the image forming unit has a curl forming part curling the recording medium, the recording medium with the image formed thereon is controlled so that the surface thereof with the image is to be concave, that is, a manner of the curl is constant. For this reason, it is not necessary to have a plurality of document pre-pressing members, and it is possible to more easily press the document. In addition, in a manner of the curl, there is also a convex curl in which the surface of the document with the image formed thereon is curled to be convex besides a concave curl in which the surface of the document with the image formed thereon is curled along a feed direction to be concave. However, even though apart of the document is pressed by the document pre-pressing member in a case that the convex curl is formed, the other part of the document is curled in the direction away from the document table. Accordingly, even though the document pre-pressing member is used, there are times when the document is moved in a case that the document table cover be rotated in the direction of covering the document table. However, according to the aspect of the invention, since the recording medium with the image formed thereon is curled so that the surface thereof with the formed image is to be concave, the above-mentioned problems do not occur and it is possible to more properly press the document by use of the document pre-pressing member.

### BRIEF DESCRIPTION OF THE DRAWINGS

The present invention may be more readily described with reference to the accompanying drawings:

FIG. 1 is a perspective view showing a multifunction printer according to a first embodiment of the invention;

FIG. 2 is a schematic cross-sectional view of the multifunction printer;

FIG. 3 is a perspective view of a scanner unit;

FIG. 4 is a front view showing a document table cover from the side on which an opening is formed;

FIGS. 5A to 5C are views for explaining a concave curl, a convex curl, and a curling amount that is a value showing an extent of curling;

FIGS. 6A and 6B are views for explaining the concave curl, the convex curl, and the curling amount;

FIG. 7 is a schematic view for explaining a peeling angle and a width of a nip portion;

FIG. 8 is a block diagram showing a construction of a control part;

FIG. 9 is a view showing a second construction of a curl forming part, and is an enlarged side cross-sectional view of a discharge tray;

FIG. 10 is a schematic view for explaining about an inclination angle in the second construction of the curl forming part; and

FIG. 11 is an R-θ2 graph showing the relation between R and θ2.

### DETAILED DESCRIPTION OF THE PREFERRED EMBODIMENTS

Hereinafter, preferred embodiments of the invention will be described with reference to the accompanying drawings.

(1) Whole Structure of a Multifunction Printer 100

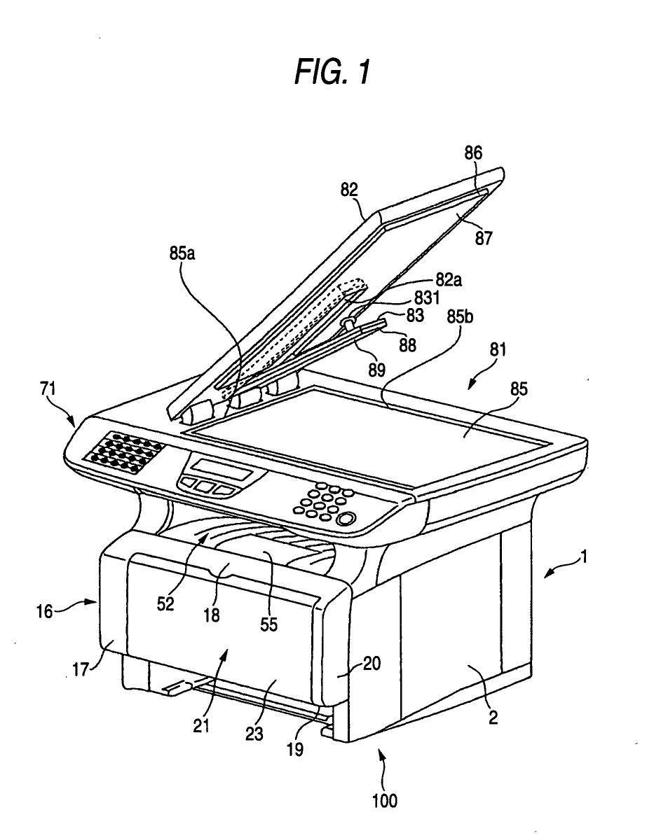

FIG. 1 is a perspective view showing an example of a multifunction printer 100 according to a first embodiment of the invention. The multifunction printer 100 includes a flat bed type scanner unit 81 serving as an image reading unit and an operation panel unit 71 which are mounted on an image forming unit 1. The image forming unit 1 forms an image on a recording medium such as a recording sheet and forms a concave curl on the recording medium. The multifunction printer 100 reads a document to obtain digital image data, and can form an image on the recording medium on the basis of the obtained digital image data. The document is disposed on a document table glass 85 serving as a document table so that a surface thereof to be read faces the document table glass 85. In addition, the multifunction printer 100 can serve as a facsimile for transmitting and receiving information.

The scanner unit 81 includes a document table glass 85, a document table cover 82, a document pre-pressing member 83, and linear wall portions 85a and 85b. The document table glass 85 is formed in a rectangular shape having long sides and short sides. One end of the document table cover 82 is rotatably supported on the side of the short side of the document table glass 85, and the document table cover 82 is rotated in the direction of covering the document table glass 85 to press the document disposed on the document table glass 85. One end of the document pre-pressing member 83 is rotatably supported on the side of the short side of the document table glass 85, and the document pre-pressing member 83 is rotated in the direction of covering the document table glass 85 to press a part of the document disposed on the document table glass 85. The linear wall portions 85a and 85b are provided on the side of the center of rotation of the document table cover 82 on the document table 85 and are protruded from the document table glass 85 to position the document. The document pre-pressing member 83 is a lever-shaped member which can be received in an opening 82a provided on the document table cover 82.

A sponge 86 made of urethane serving as an elastic member covers a document pressing surface of the document table cover 82 facing the document table glass 85, and a white film 87 made of polypropylene (PP) is attached to the document pressing surface. Also, the surface of the document pre-pressing member 83 facing the document table glass 85 is covered with a sponge 88 and a white film 89 made of the same material as described above.

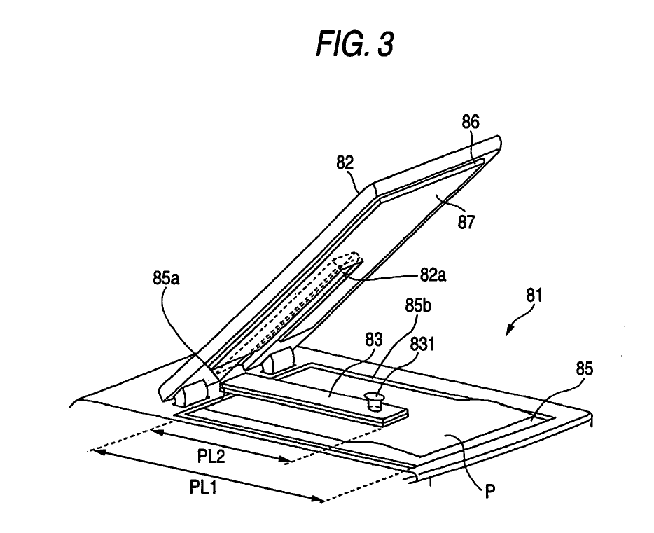

The document table cover 82 and the document pre-pressing member 83 are rotatably provided such that one ends thereof are rotatably provided on the substantially same rotation axis and the other ends thereof are rotated in the direction of covering the document table glass 85 and in the direction of opening the document table glass 85. An engaging protrusion 831 to be engaged with an engaged portion (now shown in FIG. 1) provided in the opening 82a is provided on the side of the document pre-pressing member 83. In a case that the document pre-pressing member 83 is pressing a part of the document disposed on the document table glass 85, when the document table cover 82 is rotated onto the document table glass 85 in the direction of covering the document table glass 85, the document pre-pressing member 83 is received in the opening 82a and the engaged portion is engaged with the engaging protrusion 831. For this reason, when the document table cover 82 is opened again, the document pre-pressing member 83 is rotated together with the document table cover 82 in the direction of opening the document table glass 85 in a state held in the opening 82a. Furthermore, the wall portions 85a and 85b form a step by a different height between the wall portions 85a and 85b and the document table glass 85, and are orthogonal to each other. Thus, as shown in FIG. 3, a document can be assuredly positioned by butting a corner of the document against the wall portions.

(2) A Construction of the Image Forming Unit 1

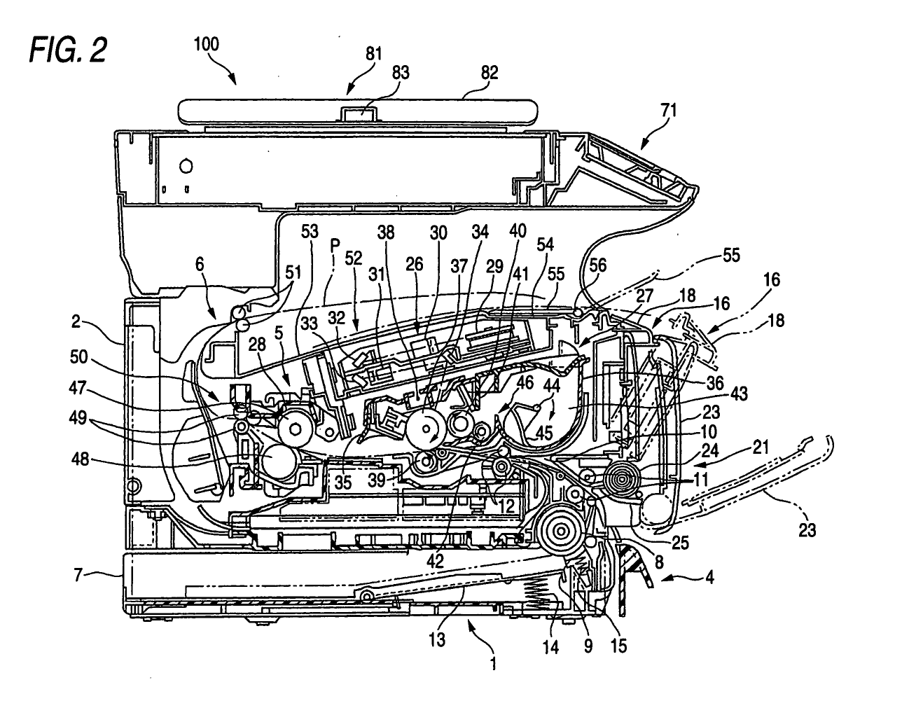

Hereinafter, the construction of the image forming unit 1 will be described in more detail with reference to FIG. 2 (and FIG. 1).

FIG. 2 is a schematic cross-sectional view of the multifunction printer 100.

The image forming unit 1 is configured as a laser printer, and includes a sheet feeding unit 4 for feeding a recording sheet P as a recording medium (a feeding path of the recording sheet P is indicated by an one-dot chain line in FIG. 2), a process part 5 for forming an image on a fed recording sheet P, and a sheet discharging part 6 for discharging the recording sheet P on which an image is formed. Further, in a description below, a side (right side in FIG. 2) in which a pick-up roller 8 of the image forming unit 1 is provided is referred to as a front side of the image forming unit 1, and a side (left side in FIG. 2) in which a fixing part 28 (to be described below) is provided is referred to as a rear side of the image forming unit 1.

The sheet feeding unit 4 is provided with a sheet feeding cassette 7, the pick-up roller 8, a sheet feeding pad 9, a sheet feed path 10, sheet powder removing rollers 11, and registration rollers 12. The pick-up roller 8 and the sheet feeding pad 9 are provided on an end (front side) of the sheet feeding cassette 7. A sheet feed path 10 is for turning over a sheet fed from the pick-up roller 8 and carrying the sheet toward the rear side. The sheet powder removing rollers 11 and the registration rollers 12 face the sheet feed path 10.

The sheet feeding cassette 7 is formed in a box shape with an opened top, and is mounted on the bottom of the main frame 2 so as to be detachable from the front side with respect to the main frame 2. A sheet pressing plate 13 and a spring 14 are provided in the sheet feeding cassette 7.

The sheet pressing plate 13 can support a stack of the recording sheets P, and is pivotably supported on one end far from the pick-up roller 8, so that the other end of the sheet pressing plate 13 close to the pick-up roller 8 can move up and down. The spring 14 is disposed so that the rear face of the end of the sheet pressing plate 13 close to the pick-up roller 8 is urged upward. Accordingly, the sheet pressing plate 13 pivots downward about the one end far from the pick-up roller 8 against an urging force of the spring 14, as the amount of the recording sheets P stacked on the sheet pressing plate 13 increases.

The pick-up roller 8 and the sheet feeding pad 9 are disposed to face each other, the sheet feeding pad 9 is pressed against the pick-up roller 8 by a spring 15 disposed on the rear side of the sheet feeding pad 9.

The uppermost recording sheets P stacked on the sheet pressing plate 13 are pressed against the pick-up roller 8 by the spring 14 disposed on the rear side of the sheet pressing plate 13 so that the uppermost recording sheet P is pinched between the pick-up roller 8 and the sheet feeding pad 9. After that, as the pick-up roller 8 rotates, the recording sheets P are fed one by one to the sheet feed path 10 by the pick-up roller 8 and the sheet feeding pad 9.

After sheet powder is removed from the fed recording sheet P by the sheet powder removing rollers 11 which are disposed above the pick-up roller 8 in the sheet feed path 10 and are composed of a pair of rollers, the recording sheet P is conveyed to the registration rollers 12. The registration rollers 12 are composed of a pair of rollers, and the recording sheet P is conveyed to an image forming location (a contacted location between a photosensitive drum 37 and a transfer roller 39) of the image forming unit 1 after the recording sheet P is registrated by the registration rollers 12.

In addition, the sheet feeding unit 4 has a multi-purpose sheet feeding unit 21 capable of supporting a stack of the recording sheets P having another size. That is, in the image forming unit 1, a front cover 16 is disposed on the front side of the main frame 2 (FIG. 1 and FIG. 2), and the multi-purpose sheet feeding unit 21 is provided in the front cover 16 (FIG. 1 and FIG. 2).

The front cover 16 has a substantial U-shape in a side view and has a substantially rectangular box-shape in a front view. The front cover 16 is formed by integrating a front wall 17, an upper wall 18, a lower wall 19, and two side walls 20 (only one side wall is shown in FIG. 1). The front cover 16 is pivotably supported on the main frame 2 in a front side of the main frame 2 by a hinge (not shown) provided on the lower wall 19. Therefore, as indicated with a phantom line in FIG. 2, the upper wall 18 can be opened and closed with respect to the main frame 2 by moving forward and backward.

The multi-purpose sheet feeding unit 21 includes a multi-purpose tray 23 (FIG. 1 and FIG. 2) provided to the front wall 17 of the front cover 16, a multi-purpose side pick-up roller 24 and a multi-purpose side sheet feeding pad 25 which are rotatably supported on a lower end of the front side of the main frame 2 in the front cover 16.

The multi-purpose tray 23 has a substantially rectangular plate-like shape in a front view as shown in FIG. 1. As indicated with a phantom line in FIG. 2, the multi-purpose tray 23 is pivotably supported on the front wall 17 of the front cover 16 by a hinge provided on a lower end thereof. Thus, the multi-purpose tray 23 can be opened and closed with respect to the front wall 17 of the front cover 16 by moving an upper end thereof forward and backward.

The multi-purpose side sheet feed roller 24 and the multi-purpose side sheet feeding pad 25 are disposed to face each other, and the multi-purpose side sheet feeding pad 25 is pressed against the multi-purpose side sheet feed roller 24 by a spring (not shown) disposed on the rear side of the multi-purpose side sheet feeding pad 25. The recording sheets P stacked on the multi-purpose tray 23 opened toward the front side are pinched between the multi-purpose side sheet feed roller 24 and the multi-purpose side sheet feeding pad 25 by the rotation of the multi-purpose side sheet feed roller 24, and then are fed one by one to the sheet feed path 10.

A process part 5 has a scan unit 2, a process unit 27 and a fixing unit 28, etc. The scan unit 26 is provided in an upper part in the main frame 2, and includes a laser-emitting portion (not shown), a polygon mirror 29 which is rotatingly operated, an fθ lens 30, a cylindrical lens 31, return mirrors 32, 33 and 34. Accordingly, as indicated with an one-dot chain line, the scan unit 26 make a laser beam, which is emitted from the laser-emitting portion on the basis of image data, passed through or reflected by the polygon mirror 29, fθ lens 30, the return mirrors 32 and 33, the cylindrical lens 31, and the return mirror 34 in this order to irradiate the laser beam on the surface of the photosensitive drum 37 of the process unit 27 with a high speed.

The process unit 27 is disposed below the scan unit 26, and has a developing cartridge 36, the photosensitive drum 37, a scorotron charger 38, and a transfer roller 39 in a drum cartridge 35, which is detachably mounted in the main frame 2. In addition, the drum cartridge 35 can be attached to and detached from the main frame 2 by opening and closing the front cover 16 provided in the front of the main frame 2.

The developing cartridge 36 is detachably mounted on the drum cartridge 35, and includes a developing roller 40, a layer-thickness regulating blade 41, a supply roller 42, and a toner hopper 43.

The toner hopper 43 is filled with toner serving as a developing agent. The toner filled in the toner hopper 43 is agitated by the rotation of an agitator 45, which is supported by a rotation shaft 44 provided in the center of the toner hopper 43, in a direction indicated by an arrow (in the clockwise direction), and then is discharged through a toner supply opening 46 which is opened on the side of the toner hopper 43.

The supply roller 42 is rotatably disposed beside the toner supply opening 46, and the developing roller 40 is rotatably disposed to face the supply roller 42. The supply roller 42 and the developing roller 40 are brought into contact with each other in a state being pressed against each other.

The supply roller 42 has a metallic roller shaft covered by a roller portion made of a conductive foam material, and is rotatingly driven in the direction indicated by an arrow (in the clockwise direction).

Moreover, the developing roller 40 has a metallic roller shaft covered by a roller portion made of a conductive rubber material, and is rotatingly driven in the direction indicated by an arrow (in the counter-clockwise direction). More specifically, the roller portion of the developing roller 40 is composed of a main roller body and a coating layer covering the outer surface of the main roller body. In this case, the main roller body is made of urethane rubber or silicone rubber which contains carbon fine particles, and the coating layer is made of urethane rubber or silicone rubber containing fluorine. Furthermore, the developing roller 40 is applied with a developing bias.

The layer-thickness regulating blade 41 is disposed in the vicinity of the developing roller 40. The layer-thickness regulating blade 41 has a blade body made of a metal leaf spring and a pressing portion made of electrically-insulating silicone rubber which is provided at a front end of the blade body and has a semicircular shape in cross-section. The layer-thickness regulating blade 41 is supported by the developing cartridge 36 in the vicinity of the developing roller 40 such that the pressing portion is pressed against the developing roller 40 by the elastic force of the blade body.

The toner discharged through the toner supply opening 46 is supplied to the developing roller 40 by the rotation of the supply roller 42. In this case, the toner is charged by friction between the supply roller 42 and the developing roller 40. In addition, as the developing roller 40 rotates, the toner supplied on the developing roller 40 is introduced between the developing roller 40 and the pressing portion of the layer-thickness regulating blade 41. As a result, the toner is formed into a thin layer shape having a predetermined thickness on the developing roller 40.

The photosensitive drum 37 is rotatably supported beside the developing roller 40 in the drum cartridge 35 such that the photosensitive drum 37 rotates in the direction indicated by an arrow (in the clockwise direction) in a state of facing the developing roller 40. The photosensitive drum 37 is composed of a drum body that is electrically grounded, and a photosensitive layer formed on the outer surface of the drum body. The photosensitive layer is made of a material such as polycarbonate that is electrically charged to a positive polarity.

The Scorotron charger 38 is disposed at a location that is above the photosensitive drum 37 and that is separated from the photosensitive drum 37 by a predetermined distance. The Scorotron charger 38 is a positively charging type. The Scorotron charger 38 includes a tungsten wire or other type charge wire, and generates corona discharge therefrom. The Scorotron charger 38 is configured so as to be capable of electrically charging the surface of the photosensitive drum 37 uniformly to a positive polarity.

The transfer roller 39 is disposed at a position below the photosensitive drum 37 and in confrontation with the photosensitive drum 37. The transfer roller 39 is supported to be rotatable in the direction indicated by an arrow (in the counterclockwise direction). The transfer roller 39 has a metallic roller shaft covered with a roller made of a conductive rubber material. The transfer roller 39 is applied with a transfer bias at the time of transfer.

The surface of the photosensitive drum 37 is first charged uniformly and positively by the Scorotron charger 38 in accordance with the rotation of the photosensitive drum 37. Next, an electrostatic latent image is formed by a laser beam from the scan unit 18. Then, the photosensitive drum faces the developing roller 40. When the toner supported on the developing roller 40 and positively charged faces and comes in contact with the photosensitive drum 37, the toner is supplied to the electrostatic latent image formed on the surface of the photosensitive drum 37, that is, to the exposed portion of the uniformly and positively charged photosensitive drum 37, which is exposed by the laser beam and whose potential is lowered, and the toner is selectively supported, so that the toner image is formed on the surface of the photosensitive drum 37 (reversal development).

Thereafter, the toner image supported on the surface of the photosensitive drum 37 is transferred to the recording sheet P by a transfer bias applied to the transfer roller 39 while the recording sheet P passes through between the photosensitive drum 37 and the transfer roller 39.

The fixing part 28 is disposed beside the process unit 27, that is, downstream of a feed direction of the recording sheet P, and includes a heating roller 47, a pressure roller 48, and a pair of conveyance rollers 49 which is disposed between the heating roller 47 and the pressure roller 48.

The heating roller 47 is formed in a thimble shape and has a heater composed of a halogen lamp built therein. The fixing heater 47 is heated by the heater.

The pressure roller 48 has an elastic body layer on the surface thereof, and is disposed to face the heating roller 47 such that the face of the recording sheet P on which toner image is not formed is pressed against the heating roller 47. The pressure roller 48 rotates in accordance with the heating roller 47 in a state pressing the heating roller 47.

In the fixing part 28, the toner transferred onto the recording sheet P is thermally fixed while the recording sheet P is passing through between the heating roller 47 and the pressure roller 48. Thereafter, the recording sheet P is conveyed to a sheet discharge path 50 of a discharge part 6 by the conveyance roller 49.

The discharge part 6 has a discharge path 50, a discharge roller 51 serving as a discharge section, and a discharge tray 52 (FIG. 1 and FIG. 2) serving as a flat plate surface. The discharge path 50 is formed as a path, which vertically extends from the conveyance roller 49 up to the discharge roller 51 disposed at a position above the conveyance roller 49.

The discharge tray 52 has a substantially rectangular plate-like shape in a front view. The rear end of the rear side of the discharge tray is disposed at a position between the conveyance roller 49 and the discharge roller 51 in a vertical direction. In the discharge tray 52, an inclined plate part 53 is formed to gradually ascend toward the front side from the rear end of the rear side, and a flat plate part 54 whose front end faces a free end of the upper side wall 18 of the front cover 16 is continuously and integrally formed with the inclined plate part 53.

The discharge tray 52 is provided with a stopper member 55 (FIG. 1 and FIG. 2) for stopping the recording sheet P that is being discharged to the flat plate part 54.

That is, in the flat plate part 54, a concave portion which has a substantially rectangular shape in a plan view is formed in a substantially center part in a width direction thereof, and the stopper member 55 is embedded in the concave portion (FIG. 1). The stopper member 55 has a substantially rectangular shape in a plan view, and is pivotally supported on the flat plate part 54 with a hinge provided on the front end of the stopper member 55. The stopper member 55 can be opened and closed with respect to the flat plate part 54 as the rear end of the stopper member 55 turns forward and backward about a hinge 56 as a fulcrum provided on the front end, as indicated with a phantom line in FIG. 2. In a development state (the state indicated with a phantom line in FIG. 2), the stopper member 55 is disposed such that its degree of inclination in a forward and upward direction is larger than that of the inclined plate part 53. Therefore, the recording sheet P to be discharged is prevented from slipping off the front end of the discharge tray 52.

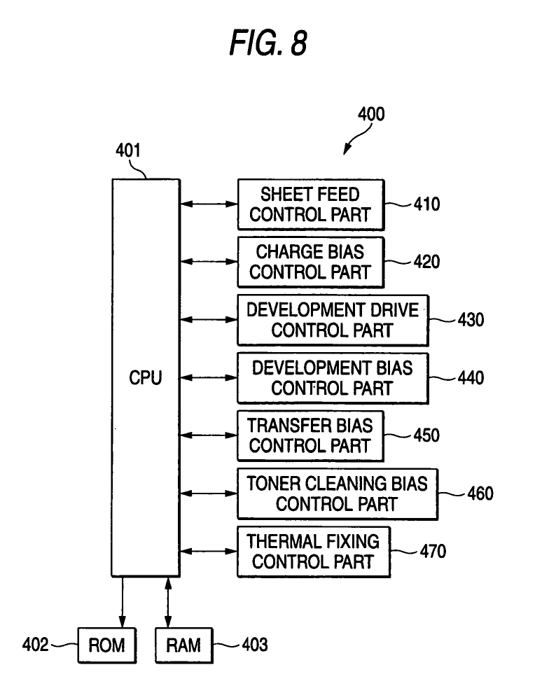

The recording sheet P conveyed to the discharge path 50 by the conveyance roller 49 is conveyed to the pair of discharge rollers 51, and then the recording sheet P is discharged on the discharge tray 52 in a direction toward the front side from the rear side by the discharge rollers 51. A control part 400 (see FIG. 8) for controlling each part of the multifunction printer 100 is provided in the image forming unit 1.

(3) Structure of the Scanner Unit 81

Hereinafter, the structure of the scanner unit 81 according to the present embodiment will be described in more detail.

FIG. 3 is a perspective view showing the scanner unit 81.

As shown in FIG. 3, when the recording sheet P serving as an object to be read is disposed on the document table glass 85 so that one surface thereof to be read faces the document table glass 85, the document pre-pressing member 83 is rotated onto the document table glass 85 in the direction of covering the document table to press a portion of the recording sheet P (hereinafter, referred to as ‘document P’ when it is an object to be read). Here, the document P is positioned in contact with the linear wall portions 85a and 85b, which are orthogonal to each other.

In the present embodiment, as shown in FIG. 3, when the document pre-pressing member 83 is closed onto the document table glass 85, a length (PL2) from the intersection between the short side of the document table glass 85 and the document pre-pressing member 83 to the opposite end of the document pre-pressing member 83 is longer than a half of the length (a length PL1 of the long side of the document glass 85 in FIG. 3) of the document table glass 85 in the direction parallel to the longitudinal direction toward the opposite end thereof.

Here, it is conceivable that a facsimile distributes received images and copies output recording sheets. In this case, a concave curl is formed on the output recording sheet by the image forming unit 1, and the recording sheet on which a concave curl is formed is generally used as the document P.

In general, when the document is curved concavely and disposed on the document table glass 85, the rising is formed at a center portion of the long side of the document P in the direction parallel to the longitudinal direction thereof (which coincides with the feed direction of the recording sheet P in this embodiment). However, if the length PL2 is longer than a half of the length PL1, the rising of the document P can be assuredly pressed by the document pre-pressing member 83. In addition, even without the document pre-pressing member 83, the document P is positioned by the wall portion 85a provided on the side of the center of rotation of the document table cover 82 and is sequentially pressed through the rotation of the document table cover 82 from the wall portion 85a side to the other end. Here, positioned portion of the document Pare already positioned by pressing so as to be held. Accordingly, even when the document table cover 82 is rotated in the direction of covering the document table glass 85 to be a closed state, the document P can be satisfactorily pressed. Further, since the wall portion 85a is formed in a linear shape, the contact area between the document P and the wall portion 85a is increased. Accordingly, it is possible to reliably position the document P. Moreover, since the document P also comes in contact with the wall portion 85b, it is possible to reliably position the document P in two directions.

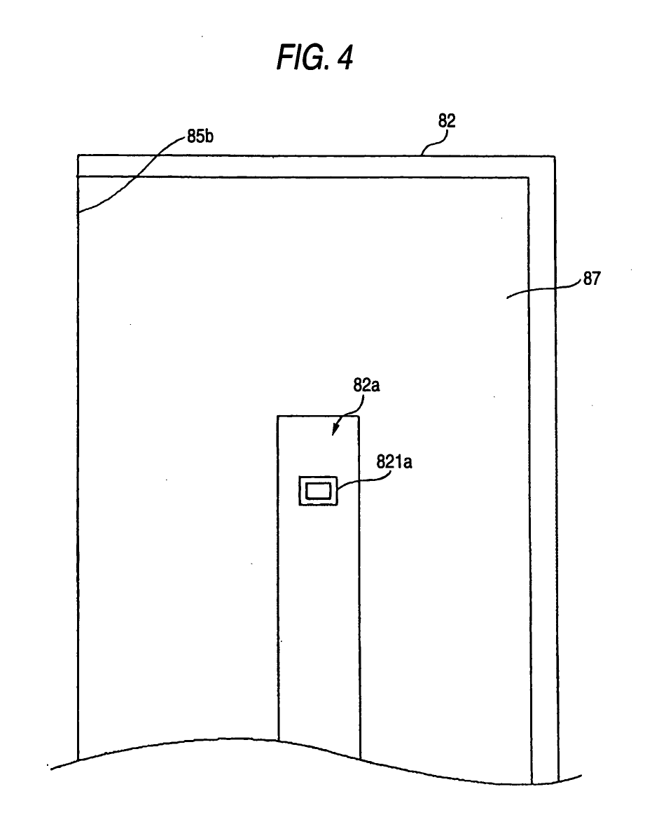

FIG. 4 is a front view of the document table cover 82 when taken from the side to which the opening 82a is formed.

The engaged portion 821a to be engaged with the engaging protrusion 831 (see FIG. 3) is provided in the opening 82a. When the document pre-pressing member 83 is received in the opening 82a, the engaged portion 821a functions to hold the document pre-pressing member 83 in the opening 82a by being engaged with the engaging protrusion 831. Accordingly, as shown in FIG. 3, in a state that the document pre-pressing member 83 presses a part of the document P, when the document table cover 82 is rotated in the direction of covering the document table glass 85 so as to press the whole document P and then is rotated in the direction of opening the document table glass 85, the document pre-pressing member 83 and the document table cover 82 is rotated together with each other in the direction of opening the document table glass 85 in a state that the document pre-pressing member 83 is received in the opening 82a. Therefore, it is not necessary that the document pre-pressing member 83 be individually operated after opening the document table cover 82.

Here, an engaging state between the engaging protrusion 831 and the engaged portion 821a, that is, the conversion between the engaging state and non-engaging state will be described.

In the present embodiment, the engaging protrusion 831 as an example of an engaging portion and the engaged portion 821a are switched to enter an engaging state or non-engaging state by pressing the document pre-pressing member 83 toward the document table cover 82.

As an example of the above-mentioned structure, for example, it is possible to use a mechanism, such as a push-type mechanism of a television device for opening and closing a lid, which covers a space receiving an operating knob and a connecter or jack for connecting with an external device. In case of using this type of a mechanism, when the document pre-pressing member 83 engaged with the document table cover 82 is pressed one time toward the document table cover 82, an engaging state is released to enter a non-engaging state. In this case, it is possible to press a part of the document P by rotating only the document pre-pressing member 83.

In addition, when the document pre-pressing member 83 is approached to the document table cover 82 and then pressed again toward the document table cover 82, the document pre-pressing member 83 and the document table cover 82 can enter the engaging state. This can be achieved as well when the document table cover 82 covers the document pre-pressing member 83 in the state shown in FIG. 3.

Since the mechanism, which switches to enter an engaging state or non-engaging state by one push, has been broadly used already, detailed description thereof is omitted. It is regarded that a mechanism disclosed in JP-A-2002-358849 is applied as an example of the above-mentioned mechanism. However, the above-mentioned mechanism is not limited thereto, and may include any mechanisms such as a mechanism using magnetic force.

(4) First Structure of a Curl Forming Part

Next, the structure of the curl forming part of the invention will be described. The curl forming part to be described below in the embodiment concavely curls a recording medium on which images is formed. ‘Concave curl’ is to curl a recording medium in the feed direction such that the surface thereof formed with the image is to be concave, when images are formed on a recording medium such as a recording sheet. The curl forming part can curl the recording medium with the image formed thereon in a direction orthogonal to the feed direction such that the surface thereof formed with the image is to be concave. Further, a ‘convex curl’ is used as a curling method contrary to the ‘concave curl’, which is to curl a recording medium in the direction orthogonal to the feed direction such that the surface thereof formed with the image is to be convex.

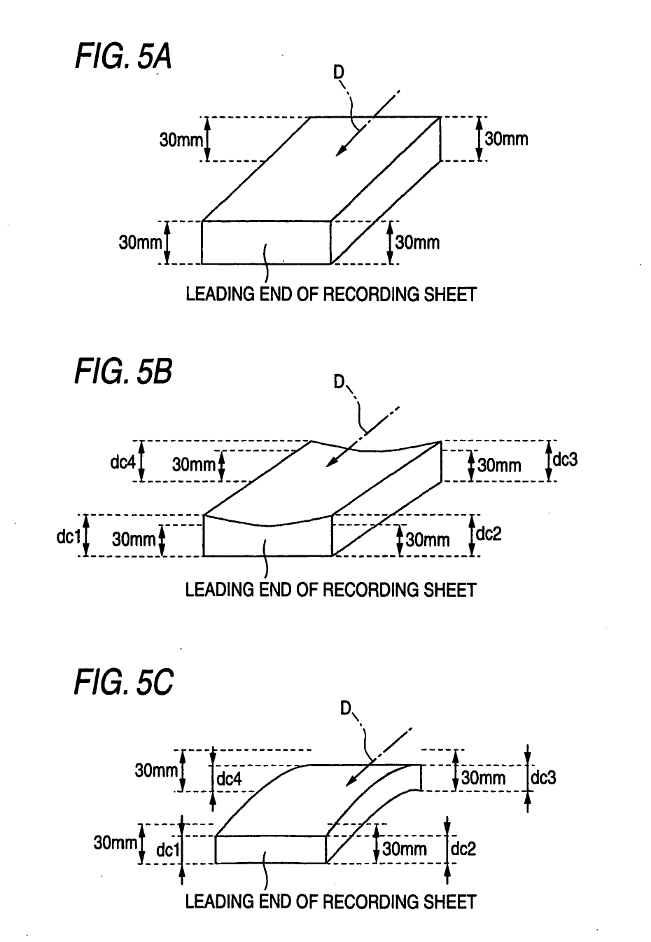

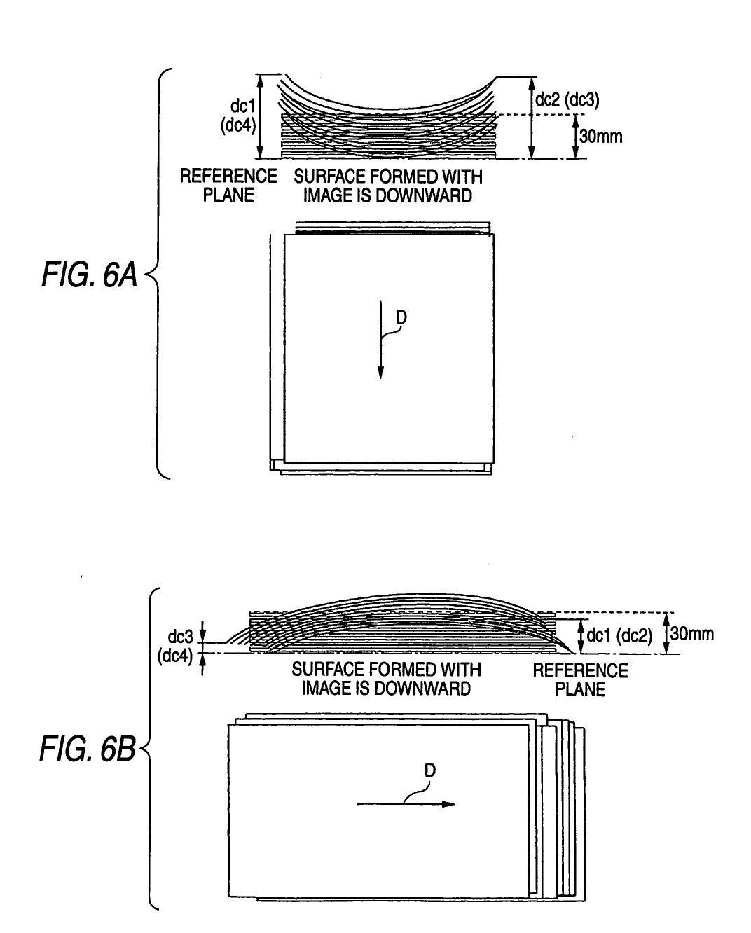

FIGS. 5A to 6B are views for explaining the concave curl and the convex curl, and for explaining a curl amount showing the extent of the curl.

An arrow D indicates the feed direction of the recording sheet P in FIGS. 5A to 6B.

FIG. 5A is a view schematically showing a state in which a curl is not formed on the recording sheet P. When for example, 200 sheets of the recording sheet P are loaded on, for example, a table, a load position, that is, each height of four corners of the recording sheet P from the table as a reference plane is 30 mm.

FIGS. 5B and 6A are views schematically showing the state in which a convex curl is formed on the recording medium P. FIGS. 5C and 6B are views schematically showing the state in which a concave curl is formed on the recording sheet P.

As shown in the drawings, when the surface thereof formed with the image faces downward, the convex curl is a curl state in which the recording sheet P is warped such that both sides thereof orthogonal to the feed direction D are lifted upward. Therefore, in a case that the convex curl is formed on the recording sheet P, when a part of a document are pressed by the document pre-pressing member 83, other part that are not pressed are likely to be warped upward. Further, when the document table cover 82 is closed, the document may move.

The present inventors have performed experiments for measuring the extent of the curl formed on the recording sheet P with the formed image. Hereinafter, the experiments will be described with reference to FIGS. 5A to 6B.

The inventors has specified a setting value and a dimension value that are adjustable, among factors which can affect the extent of the curl to be formed on the recording sheet P, and individually changed the setting value and the dimension value of those factors within the range to be described below. One surface (printing surface) of 200 sheets of the recording sheet P is continuously printed per each setting with a print proportion of 4%, and an extent of the curl formed on 200 sheets of the recording sheet P has been measured.

In the experiments, ‘DataCopy’ (a recording sheet with a size of A4 and a weight of 80 g) manufactured by Modo is used as the recording sheet P. In addition, the experiments were performed under the condition in which the temperature is 23° C. and the humidity is 60%. The above-described factors and setting values can be changed within the range as follows:
(A) Temperature for controlling the heating roller 47 Thr (° C.): 155° C. to 225° C.
(B) Peeling angle θ(°): −10.3° to 1.7°
(C) Diameter of the pressure roller 48 Dpr (mm): 25 mm to 35 mm
(D) Width of a nip portion Wnip (mm): 6.3 mm to 7.8 mm

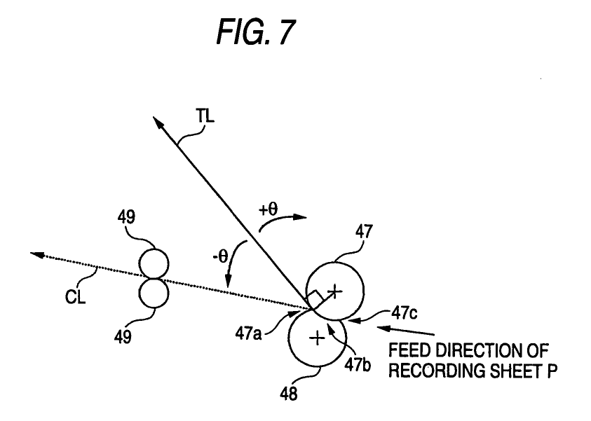

Here, the ‘peeling angle θ’ and the ‘width of a nip portion Wnip’ will be described. FIG. 7 is a schematic view for explaining the ‘peeling angle θ’ and the ‘width of a nip portion Wnip’.

As shown in FIG. 7, the ‘peeling angle θ’ is an angle formed between a tangential line TL and a discharge direction CL in a plan view which is orthogonal to the axis of the heating roller 47. The tangential line TL is tangent on the surface of the heating roller 47 at the lowest point 47a in the recording medium feed direction of a nip portion 47b. The recording sheet P is discharged in the direction CL (toward the conveyance roller 49).

With respect to the tangential line TL in FIG. 7, when the direction CL is located in a direction indicated by an arrow +θ, the peeling angle θ is positive, and when the direction CL is located in a direction indicated by an arrow −θ, the peeling angle θ is negative. Therefore, when the tangential line TL coincides with the direction CL, the peeling angle θ is defined as zero θ=0°.

In addition, the ‘width of a nip portion Wnip’ is a distance (the contacted length of the nip portion in the recording sheet feed direction) from the lowest point 47a in the recording medium feed direction to a highest point 47c along an arc in a direction orthogonal to the axis of the heating roller 47, in the nip portion 47b shown in FIG. 7.

In this embodiment, an extent of curling (hereinafter, the curling amount is indicated with Δdc) is defined as follows. That is, after 200 sheets of the recording sheet P loaded on the reference plane such as a table are continuously formed, one of the leading end corners, among the four corners of the stacked 200 sheets of the recording sheet P, is set as dc1 mm in height from the reference plane. Thereafter, heights of the rest of the four corners are respectively set as dc2 mm, dc3 mm, and dc4 mm in the counter-clockwise direction (see FIGS. 5B and 5C). Otherwise, when a curl is not caused on the stacked recording sheets P, a height from the reference plane is set as a reference height that is 30 mm in this embodiment (see FIG. 5A).

As indicated with an expression (1), the curling amount Δdcn mm on each corner is obtained by subtracting the reference height from the height of each corner. Incidentally, n is a natural number 1 to 4.
Δdcn=dcn−30 (1)

An average value Δdc mm of the curling amount Δdcn of each corner obtained by calculating the expression (1) can be obtained by calculating an expression (2)
Δdc=(Δdc1+Δdc2+Δdc3+Δdc4)/4 (2)

Here, when the ‘convex curl’ is caused on the recording sheet P, the curling amount Δdc is positive. On the other hand, when the ‘concave curl’ is cause on the recording sheet P, the curling amount Δdc is negative. This is because the value of the curling amount Δdc1 to Δdc4 is likely to be negative in case of the ‘concave curl’, since in the experiment performed by the inventors, each location of four corners is not true up, and the curling amount Δdc1 to Δdc4 is measured while maintaining the discharged state, as shown in FIGS. 6A and 6B. Therefore, it is conceived that the concave curl can be caused on the recording sheet P when the following expression (3) is satisfied.
Δdc<0 (3)

The inventors have obtained a regression coefficient about each factor by performing multiple regression analysis of a multivariate analysis technique on the basis of the result of the experiment for measuring the curling amount which is performed as described above. In order to achieve conditions which enable the concave curl to be caused on the recording sheet P as described above, a multiple regression expression (4) is derived.
Δdc=0.55×Thr−2.36×θ−1.59×Dpr+8.62×Wnip−124 (4)

A multiple regression expression is a linear expression using a plurality of variables, and is generally represented as an expression (5) as follows.
y=a1×x1+a2×x2+ . . . +ap×xp+a0 (5)

In the expression (5), y indicates ‘target variables’, x1, x2, . . . and xp indicate ‘explanation variables’, a0 indicates ‘constant term’, and a1, a2 . . . and ap indicate a ‘regression coefficient’.

In this embodiment, the following expression (6) is derived from the expressions (3) and (4). That is, it is conceived that the concave curl is formed on the recording sheet P when conditions of the expression (6) are satisfied.
0.55×Thr−2.36×θ−1.59××Dpr+8.62×Wnip<124 (6)

Specific examples of each component to satisfy the conditions of the expression (6) are as follows.
(A) Temperature for controlling the heating roller 47 Thr (° C.): 195° C.
(B) Peeling angle θ (°): 11°
(C) Diameter of the pressure roller 48 Dpr (mm): 30 mm
(D) Width of a nip portion Wnip (mm): 7 mm

By setting conditions as described above, the concave curl can be caused on the recording sheet P on which images are formed. In this way, the document can be prevented from moving when the document table cover 82 is closed as well as properly pressing a part of the document by using the aforementioned document pre-pressing member 83.

Hereinafter, a construction of the control part 400 for controlling the temperature of the above-described heating roller 47 serving as the curl forming part will be described.

FIG. 8 is a block diagram showing the construction of the control part 400.

As shown in FIG. 8, the control part 400 includes a CPU 401, to which a sheet feed control part 410, a charge bias control part 420, a development drive control part 430, a development bias control part 440, a transfer bias control part 450, a toner cleaning bias control part 460, and a thermal fixing control part 470 are respectively connected.

The CPU 401 is connected to ROM 402 and RAM 403. Various control programs such as a main drive control program for controlling each control part of the sheet feed control part 410 or the like is stored in the ROM 402. Thus, control processing of each part is performed by the program. Temporary numerical values or the like for driving and controlling each part are stored in the RAM 403.

In this embodiment, the thermal fixing control part 470 is particularly controlled by the CPU 401 so as to control the temperature of the heating roller 47, and thus the curl forming part is realized. Since a method of the control processing of each part follows a known technique, a detailed description thereof will be omitted here.

(5) Second Construction of the Curl Forming Part

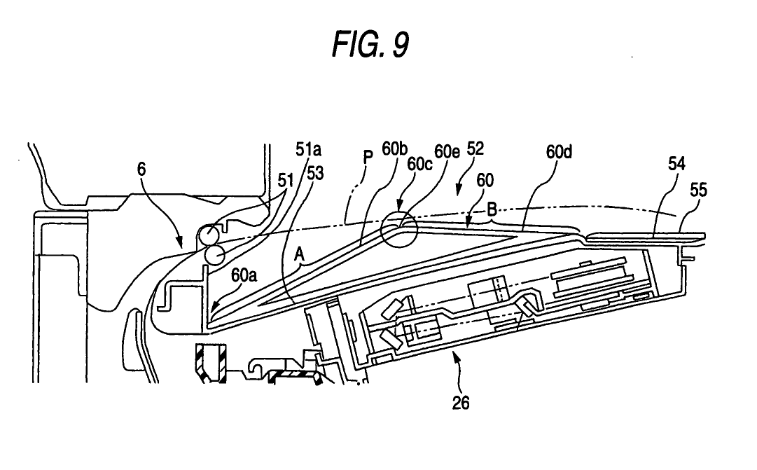

The method of causing the concave curl on the recording sheet P is not limited to the above-described method, and the concave curl can be caused on the recording sheet P through various methods. Hereinafter, the second construction of the curl forming part will be described. In the second construction, by studying shapes on the surface of the discharge tray 52, the concave curl is formed on the recording sheet P on which images are formed by suppressing the convex curl from being caused on the recording sheet P. FIG. 9 is a view for explaining the construction, and is an enlarged side cross-sectional view of the discharge tray 52.

In this construction, a replaceable adapter 60 which can be disposed on the discharge tray 52 is provided. The replaceable adapter 60 is constructed so as to be detachable from the discharge tray 52, and is mounted on the inclined plate part 53 of the discharge tray 52. The replaceable adapter 60 is formed to have such a size that covers the inclined plate part 53. When the replaceable adapter 60 is disposed on the discharge tray 52, a curved sheet placement surface in which a convex part 60c projects upward is formed between the lower end 60a of a contacted surface 51a and the other end. The contacted surface 51a comes into contact with the rear side end of a discharged recording sheet P, as an end of the upper stream side (rear side) in the discharge direction of the discharge roller 51. The other end is the down stream side (front side) in the discharge direction of the discharge roller 51.

To be more specific, when the replaceable adapter 60 is mounted on the inclined plate part 53, the surface on the one end (60a) side from a top portion 60e of the convex part 60c is formed so as to be inclined upward by about 30° with respect to the horizontal direction.

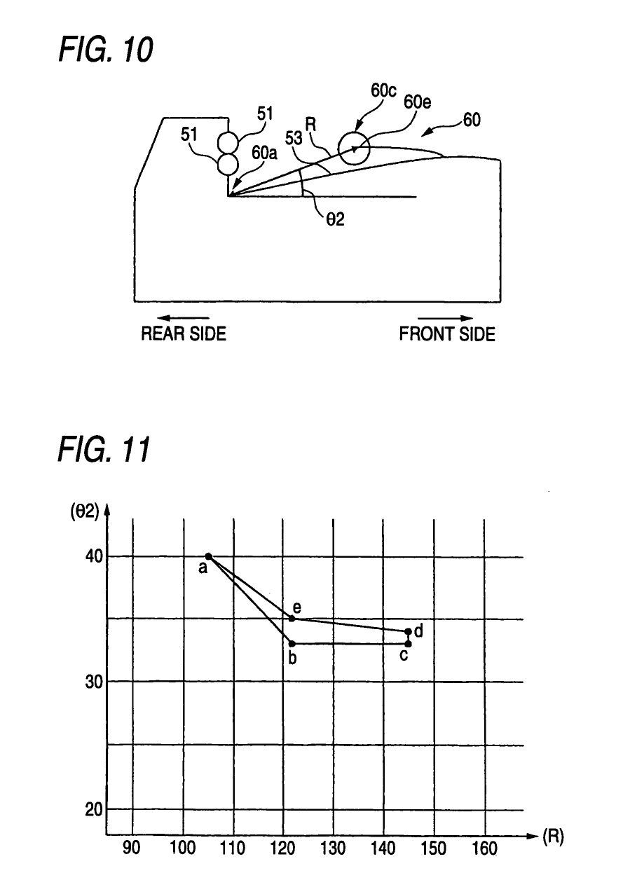

FIG. 10 is a schematic view for explaining about the inclination angle θ2.

In addition, when the recording sheet P is placed on the other end portion, the other end (front side) portion (60d in FIG. 9) from the top portion 60e of the convex part 60c is formed to make an angle with respect to the horizontal direction within such a range that prevents the recording sheet P from moving by its own weight in the discharge direction (in the front side direction).

The replaceable adapter 60 is formed larger than the recording sheet P in width in a direction orthogonal to the discharge direction of the recording sheet P. Therefore, the convex part 60c is formed larger in width than the recording sheet P as well. In addition, in the replaceable adapter 60, the distance (which corresponds to R in FIG. 10, or the length indicated with reference numeral A in FIG. 9) from the one end 60a on the discharge roller 51 side to the top portion 60e of the convex part 60c is set 49% of the length (297 mm that is the length in the longitudinal direction of A4 sheet, to be conveyed in a direction parallel to the longitudinal direction in this embodiment) of A4 sheet in the discharge direction (in the feed direction). This is defined in respect that the concave curl is formed on the recording sheet P discharged on the replaceable adapter 60. In this way, a concave curl generating part is constructed by forming the convex part on the discharge tray 52.

Although a specific type of the replaceable adapter 60 for constructing the curl forming part by mounting the replaceable adapter 60 has been described, the invention is not limited to the specific construction. Hereinafter, the shape of the replaceable adapter 60 has been variously modified and the shape of the replaceable adapter 60 which can cause the concave curl on the recording sheet P has been studied. Thus, the result of the study will be described.

FIG. 11 is an R-θ2 graph showing the relation between R and θ2.

Namely, FIG. 11 is a graph for explaining about the result of the study on a curl generating state of the recording sheet P when the recording sheet P on which images are formed is mounted on the replaceable adapter 60.

As shown in FIG. 10, the replaceable adapter 60 is configured by changing parameters composed of R and θ2. Reference numeral θ2 indicates an inclination angle. The surface on the one end side (rear side) from the top portion 60e of the convex portions 60c forms an angle θ2 with respect to the horizontal direction, the surface is inclined upward θ2 from the one end 60a. Reference numeral R indicates the distance from the one end 60a of the replaceable adapter 60 up to the top portion 60e of the convex part 60c. In addition, the recording sheet used in this experiment is ‘DataCopy (trademark)’ manufactured by Modo and ‘Recyclingcopy’ manufactured by STEINBEIS, which are A4 80 g/m² recording sheet.

As a result, with the replaceable adapter 60 which is designed with parameters within the range of portions (portions surrounded by points a to e) indicated in FIG. 11, the convex curl is not caused on the recording sheet P at all but the concave curl is formed.

Each point of the distance R and the angle θ2 has a pair of co-ordinates (R, θ2) on the graph, and their co-ordinates are a (105, 40), b (122, 33), c (145, 33), d (145, 34) and e (122, 35).

As can be seen from the graph in FIG. 11, the angle θ2 is preferably 33° to 40°, that is, points a and b, and the distance R is preferably 105 mm (35%) to 145 mm (49%), that is, points a and c. The denotation % in parentheses means the ratio of the longitudinal length of A4 recording sheet.

The angle formed between the surface on the one end (rear side) from the top portion 60e of the convex part 60c and the surface on the other end (front side) from the top portion 60e is preferably 120° to 165°. The surface on the one end (rear side) from the top portion 60e of the convex part 60c is indicated with reference numeral A in FIG. 9, and the surface on the other end (front side) from the top portion 60e is indicated with reference numeral B in FIG. 9.

When the recording sheet P is discharged on the discharge tray 52 on which the replaceable adapter 60 having the above-described shape is mounted, the recording sheet P is placed such that a substantial center portion of the recording sheet P in the feed direction rises above, when taken from a section view along the discharge direction. For this reason, both side ends in a direction orthogonal to the discharge direction of the recording sheet P is prevented from being warped upward, thus preventing the above-described convex curl from being formed.

The distance R from the one end 60a on the discharge roller 51 side to the top portion 60e of the convex part 60c is set substantially 35% to 49% of the length (in a lengthwise direction in this embodiment) in the discharge direction of the recording sheet P. With this construction, the convex curl can thus be effectively prevented from being formed, and the concave curl can be caused on the recording sheet P.

In the embodiment, a portion closer to the front side than the front end of the inclined plate part 53 is made the flat plate part 54 so as to provide the stopper member 55. However, the stopper member 55 does not need to be provided. In case that the stopper member 55 is not provided, when the recording sheet P is mounted on the surface on the other end (front side) from the top portion 60e of the convex part 60c which is indicated with reference numeral B in FIG. 9, and the flat plate part 54 to be connected to the surface, the recording sheet P forms an angle with respect to the horizontal surface within such a range that prevents the recording sheet P from moving and falling by its own weight.

With this construction, the recording sheet P is prevented from falling on the front side of the discharge tray 52. The convex part 60c is preferably formed such that the angle (corner) made between the surface on the one end (rear side) from the top portion 60e of the convex part 60c which is indicated with reference numeral A in FIG. 9, and the surface on the other end (front side) from the top portion 60e which is indicated with reference numeral B in FIG. 9 is 120° to 165°, more preferably, 130° to 150°. When the angle is formed within the range, the convex curl is especially prevented from generating, thus properly causing the concave curl.

Since the convex part 60c is disposed with a larger width than the width of the recording sheet in a sheet width direction orthogonal to the discharge direction of the recording sheet P, even when the discharged recording sheet P is deviated from the sheet width direction, the recording sheet P can be placed in the same shape as that of the convex part 60c. Thus, the concave curl can be caused.

The replaceable adapter 60 described in the embodiment uses the A4 recording sheet as a recording medium. However, even when a replaceable adapter which uses other size than A4 as a recording medium is formed, the concave curl can be caused on the recording sheet.

As described above, the image forming unit 1 causes the concave curl on the discharged recording medium P by mounting the replaceable adapter 60 to the discharge tray 52. However, a convex part can be disposed by changing the shape of the discharge tray 52, without mounting the replaceable adapter 60. Thus, the function as the concave curl generating part can be realized in this way.

It is preferable that the interior part corresponding to the region in which the replaceable adapter 60 is mounted be empty. That is, by using the replaceable adapter 60 whose interior part is empty, heat generated from each unit provided in the image forming unit 1 is prevented from being transferred onto the recording sheet P. Thus, the heat is prevented from causing the convex curl on the recording sheet P. Therefore, even when the replaceable adapter 60 is not mounted, the same effect can be achieved by emptying the region in which the replaceable adapter 60 is supposed to me mounted. In addition, in respect that the empty region is insulated from heat, the region is preferably made vacuum.

(Modification)

Although the embodiment of the invention were described above, the application of the present invention is not limited to the above-described specific embodiment, and it can be modified in various forms as follows.

(1) In the embodiment, one end of the document table cover 82 is pivotally supported on a short side of the document table glass 85 which is formed in a rectangular shape having long sides and short sides, and the document table cover 82 turns in the direction of covering the document table glass 85 and in a direction that uncovers the document table glass 85. In this case, the one end is parallel to the short side of the document table glass 85. However, one end of the document table cover 82 can be pivotally supported on the long side of the document table glass 85. In this case, the one end is parallel to the long side of the document table glass 85. Further, one end of the document pre-pressing member can be pivotally supported on the long side of the document table glass 85.

(2) In the embodiment, one end of the document pre-pressing member 83 is provided in the substantial center part of the short side of the document table glass 85. However, the one end does not need to be provided in the substantial center part. That is, in the case of the above embodiment, the ridge of the curled portion of the recording sheet P that is curved by the curl forming part is substantially parallel to a short side of the recording sheet P (in order to be conveyed in the long side direction of the recording sheet P while forming images). When the recording sheet P is positioned such that its long side and short side are respectively in contact with the long side and the short side of the document table glass 85, the longitudinal direction of the document pre-pressing member 83 is substantially orthogonal to the curved direction of the curved portion. Thus, the recording sheet can be properly pressed without providing the document pre-pressing member 83 in the substantial center part.

(3) In the embodiment, the document table glass 85 is formed in a rectangular shape having long sides and short sides. However, the shape of the document table is not limited to the rectangular shape.

(4) In the embodiment, the document pre-pressing member 83 is formed in a lever shape. However, the shape is not limited to the lever shape, a member composed of a plurality of members that are connected to each other may be used. For example, a member made by arranging two levers and connecting portions of the two levers to have a U-shape can be conceivable.

(5) In the embodiment, in constructing the first curl forming part, the temperature for controlling the heating roller Thr (°) is controlled to satisfy the expression (1).

The expression is derived from the result of the actual experiment by multiple regression analysis. The expression is appropriate under general conditions. However, for example, under an environment of an extremely high temperature, other expressions can be individually obtained.

(6) In constructing the second curl forming part, for example, a document pressing member which presses from above the recording sheet P loaded downstream of the discharge roller 51 in the discharge direction can be provided. When this document pressing member is provided, the recording sheet P that is discharged on the discharge tray 52 can be prevented from falling.

(7) In the embodiment, the replaceable adapter 60 in which the top portion 60e of the convex part 60c is formed in a substantially parabolic shape in a section view is used. However, a triangle shape in a section view or a trapezoidal shape may be formed without curving the top portion 60e.

(8) In the embodiment, the curl forming part curves the recording sheet in the feed direction such that the surface thereof formed with the image is to be concave, which is the concave curling. However, the curl forming part may curve the recording sheet such that the surface thereof formed with the image is to be concave in a direction orthogonal to the feed direction. For example, in the construction of the second curl forming part, the shape of the surface of the discharge tray 52 is preferably formed in such a curved shape that its ridge line is parallel to the recording sheet discharge direction.

(9) In the embodiment, the multifunction printer which generates digital image data by reading a document placed on a document table has been described as an example. However, the present invention can be applied to an analog type multifunction printer, which reads a document and forms images. Here, the multifunction printer is not limited to functioning as using digital image data in forming images or functioning as a facsimile for transmitting and receiving information.

(10) In the embodiment, the present invention is applied to the multifunction printer having a document reading part and an image forming unit, and the effect in which the concave curl is formed on a document on which images are formed so as to properly press the document by the document pre-pressing member is gained. However, the effect can be gained by applying the invention to, for example, a printing system to which a scanner serving as an image reading device and a printer serving as an image forming device are connected. Although the image reading can be connected to the image forming device by exclusive cables, the connection between the image reading and the image forming device is not limited thereto and may include any connections such as a connection through various network such as LAN.

(11) In the embodiment, a document can be reliably positioned since the wall portion 85a formed in a straight shape is in contact with the document over a large area. However, the shape of the wall portion is not limited to the straight shape; for example, a plurality of protrusions which is in contact with the document is possibly adopted as long as the locations of the protrusions are on a line.

(12) In the embodiment, the document pre-pressing member is used. However, without the document pre-pressing member, a document can be positioned when the wall portions for positioning exist. In addition, besides the wall portion forming a step, a clip-shaped part which sandwiches a document therebetween can use as a positioning part.

The present invention can be applied to a multifunction printer which reads a document placed on a document table so as to form images, a printing system, and an image forming device or the like.

What is claimed is:

1. An image forming apparatus comprising:
an image reading unit that reads a document and comprises:
a document table on which the document is placed;
a document table cover having one end capable of swinging about the other end thereof and a document pressing surface formed with an opening, the document table cover rotating in a first direction away from the document table and in a second direction toward the document table, the document pressing surface being capable of pressing the document; and
a document pre-pressing member that is received in the opening and has one end capable of swinging about the other end thereof, the document pre-pressing member being capable of rotating in the first direction and in the second direction, the document pre-pressing member being capable of pressing a part of the document on the document table in a state where the document table cover is open; and
an image forming unit that forms an image of the document read by the image reading unit on a recording medium, the image forming unit comprising a curl forming part that curls the recording medium so that a surface of the recording medium formed with the image thereon is to be concave.

2. The image forming apparatus according to claim 1, wherein the curl forming part curls the recording medium along a feed direction so that the surface of the recording medium formed with the image thereon is to be concave.

3. The image forming apparatus according to claim 1, wherein the document table and the recording medium have a rectangular shape with long sides and short sides;
the document pre-pressing member has a width shorter than the short side of the document table; and
when the long side and the short side of the recording medium curled by the curl forming part are aligned with the long side and the short side of the document table, respectively, the document pre-pressing member is capable of pressing the document while extending orthogonally to a direction along which a ridge of a curl of the recording medium extends.

4. The image forming apparatus according to claim 1, wherein the document pre-pressing member is composed of one member or several members connected mutually.

5. The image forming apparatus according to claim 3, wherein when the document pre-pressing member covers the document table, a length from the intersection between the long side or the short side of the document table and the document pre-pressing member to the opposite end of the document pre-pressing member is longer than a half of the length of the document table in a direction parallel to a longitudinal direction of the pre-pressing member.

6. The image forming apparatus according to claim 3, wherein the other end of the document table cover is connected to one side of the short and long sides of the document table, and the other end of the document pre-pressing member is connected to substantially a central part of the one side of the document table.

7. The image forming apparatus according to claim 6, wherein the other end of the document table cover is connected to the short side of the document table; and
the image forming unit feeds the recording medium in a longitudinal direction of the recording medium.

8. The image forming apparatus according to claim 6, wherein the other end of the document table cover is connected to the long side of the document table; and
the image forming unit feeds the recording medium in a direction orthogonal to a longitudinal direction of the recording medium.

9, The image forming apparatus according to claim 1, further comprising:
a feeding unit that feeds a recording sheet having a size of A4 serving as the recording medium;
a developing unit that forms an image on the recording sheet by use of a developing agent; and
a fixing unit that comprises a heating roller and a pressure roller, the pressure roller having an elastic body layer on a surface thereof, the pressure roller being provided so as to face the heating roller to press the recording sheet with the image formed thereon against the heating roller;
wherein assuming that a nip portion is formed by deforming the elastic body layer in accordance with a surface shape of the heating roller when the pressure roller is pressed toward the heating roller, θ (°) is a peeling angle between a tangential line of the heating roller and a discharge direction of the recording sheet at the most downstream point of the nip portion in a recording sheet feed direction on a plane orthogonal to a central axis of the heating roller, Dpr (mm) is a diameter of the pressure roller, and Wnip (mm) is a length for which the recording sheet contacts the nip portion in the feed direction, the curl forming part controls a temperature Thr (° C.) of the heating roller so as to satisfy an inequality shown in the following expression:
0.55×Thr−2.36×θ−1.59×Dpr+8.62×Wnip<124.

10. The image forming apparatus according to claim 9, wherein the feeding unit feeds the recording sheet in a longitudinal direction of the recording sheet.

11. The image forming apparatus according to claim 1, further comprising:
a discharging part having a placement surface on which the recording medium is placed and discharging the recording medium so that the surface formed with the image faces the placement surface;
wherein the curl forming part comprises a convex portion protruding toward the recording medium between one end on an upper stream side and the other end of the placement surface, a surface of the convex portion between an apex of the convex portion and one end on the upper stream side thereof is inclined by an angle within the range of 33 to 40° with respect to a horizontal direction, and a distance from the one end to the apex is in the range of about 35 to 49% of a length of the recording medium in the feed direction thereof.

12. The image forming apparatus according to claim 11, wherein the recording medium is a recording sheet having a size of A4, the recording sheet is fed in the direction parallel to a longitudinal direction thereof, and a distance from the one end to the apex is 105 mm or more and 145 mm or less.

13. The image forming apparatus according to claim 1, wherein the document table cover includes a holder for holding the document pre-pressing member; and
when the document table cover is rotated onto the document table in a situation where the document pre-pressing member presses the document, the holder holds the document pre-pressing member in the opening even after the document table cover is rotated in the first direction.

14. The image forming apparatus according to claim 13, wherein the document pre-pressing member has an engaging portion in a position facing the opening of the document table cover, the document table cover has an engaged portion engaged with the engaging portion, and the engaging portion and the engaged portion are switched to enter an engaging state or non-engaging state by pressing the document pre-pressing member toward the document table cover.

15. The image forming apparatus according to claim 1, wherein an elastic member is disposed on each of the document pressing surface of the document table cover and a surface of the document pre-pressing member facing the document table.

16. The image forming apparatus according to claim 15, wherein a side of the elastic member facing the document table is white.

17. The image forming apparatus according to claim 1, wherein the image reading unit further comprises a positioning portion that positions the document and is provided on the side of the other end of the document table cover.

18. The image forming apparatus according to claim 17, wherein the positioning portion comprises a wall portion protruding from the document table so that an end of the document abuts on the wall portion.

19. The image forming apparatus according to claim 18, wherein an abutting surface, to which the document is abutted, is linearly formed on the wall portion.

20. A printing system comprising:
an image reading device that reads a document and comprises:
a document table on which the document is placed;
a document table cover having one end capable of swinging about the other end thereof and a document pressing surface formed with an opening, the document table cover rotating in a first direction away from the document table and in a second direction toward the document table, the document pressing surface being capable of pressing the document; and
a document pre-pressing member that is received in the opening and has one end capable of swinging about the other end thereof, the document pre-pressing member being capable of rotating in the first direction and in the second direction, the document pre-pressing member being capable of pressing a part of the document on the document table in a state where the document table cover is open; and
an image forming device that communicates with the image reading device and forms an image on a recording medium on the basis of image data obtained by reading the document though the image reading device, the image forming device comprising a curl forming part that curls the recording medium so that a surface of the recording medium formed with the image thereon is to be concave.

21. An image forming device comprising:
a developing unit that forms an image on a recording sheet having a size of A4 by use of a developing agent;
a fixing unit that comprises a heating roller and a pressure roller, the pressure roller having an elastic body layer on a surface thereof, the pressure roller being provided so as to face the heating roller to press the recording sheet with the image formed thereon against the heating roller; and
assuming that a nip portion is formed by deforming the elastic body layer in accordance with a surface shape of the heating roller when the pressure roller is pressed toward the heating roller, θ (°) is a peeling angle between a tangential line of the heating roller and a discharge direction of the recording sheet at the most downstream point of the nip portion in a recording sheet feed direction on a plane orthogonal to a central axis of the heating roller, Dpr (mm) is a diameter of the pressure roller, and Wnip (mm) is a length for which the recording sheet contacts the nip portion in the feed direction, a curl forming part that controls a temperature Thr (° C.) of the heating roller so as to satisfy an inequality shown in the following expression:
0.55×Thr−2.36×θ−1.59×Dpr+8.62×Wnip<124.

22. An image forming apparatus comprising:
an image reading unit that reads a document and comprises:
a document table on which the document is placed;
a document table cover having one end capable of swinging about the other end thereof, the document table cover rotating in a first direction away from the document table and in a second direction toward the document table, the document table cover being capable of pressing the document; and
a positioning portion that positions the document and is provided on the side of the other end of the document table cover; and
an image forming unit that forms an image of the document read by the image reading unit on a recording medium, the image forming unit comprising a curl forming part that curls the recording medium so that a surface of the recording medium formed with the image thereon is to be concave.

23. The image forming apparatus according to claim 22, wherein the positioning portion comprises a wall portion protruding from the document table so that an end of the document abuts on the wall portion.

24. The image forming apparatus according to claim 23, wherein the wall portion comprises two abutting surfaces, to which a corner of the document is abutted, the two wall surfaces being linearly formed on the wall portion and orthogonal to each other.

25. The image forming apparatus according to claim 22, wherein the image forming apparatus further includes a facsimile transmitting/receiving function, and the image forming unit forms a received image received by the facsimile receiving function on the recording medium.
